(19) United States
(12) Patent Application Publication
(10) Pub. No.: US 2009/0174594 A1
(43) Pub. Date: Jul. 9, 2009

(54) HIGH FREQUENCY RADAR ALTIMETER

(75) Inventors: Steven H. Thomas, Brooklyn Center, MN (US); Timothy J. Reilly, Plymouth, MN (US); Glen B. Backes, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/401,639

(22) Filed: Mar. 11, 2009

Related U.S. Application Data
(62) Division of application No. 11/462,911, filed on Aug. 7, 2006.

(51) Int. Cl. G01S 13/16; G01S 13/18; G04F 10/02

(52) U.S. Cl. 342/94; 368/118; 342/120; 342/100; 342/175

(57) ABSTRACT

In one aspect, a method of radar altimeter operation, the altimeter including a high frequency counter coupled to a processor is described. The method comprises providing a continuous wave to the high frequency counter upon receipt of a transmit pulse, counting the cycles of the continuous wave, discontinuing counting of the continuous wave cycles upon receipt of a return pulse, outputting a count from the high frequency counter to the processor, and operating the processor to convert the count to an altitude.

### CROSS REFERENCE TO RELATED APPLICATIONS

This application is a divisional of U.S. patent application Ser. No. 11/462,911, filed on Aug. 7, 2006 and entitled “HIGH FREQUENCY RADAR ALTIMETER” (the '911 application). The '911 application is incorporated herein by reference.

### BACKGROUND OF THE INVENTION

This invention relates generally to radar altimeters, and more specifically, to methods and systems of radar altimeter signal processing.

Navigation of an aircraft in all phases of flight is based to a large extent upon determining the terrain over which the aircraft is passing, and is further based upon determining a position of the aircraft. Aircraft instrumentation, sensors, radar systems, and radar altimeters are used in combination with accurate electronic terrain maps to assist in navigation. The electronic terrain maps in combination with the radar altimeter aid in the flight planning and in determining an actual flight path for the aircraft.

Radar altimeters are commonly implemented within aircraft and typically include a transmitter and an antenna which radiates energy, in the form of a transmit beam, towards the earth's surface. A transmit beam from a radar is sometimes said to “illuminate” or “paint” an area which reflects the transmit beam.

Known radar altimeters further include a signal receiver and a receive antenna. The receive antenna receives return pulses, sometimes referred to as an echo or a return signal. Such return pulses represent a portion of the transmitted beam that has been reflected from the earth's surface. In some known radar altimeters, a same antenna is utilized for both transmitting and receiving.

Known radar altimeters also include a closed loop servo tracker for measuring the time interval between transmission of a transmitted pulse and receipt of its associated return pulse. The time interval between transmission of the transmit pulse and receipt of the return pulse is directly related to the altitude of the aircraft.

Known radar altimeters are very complex. Radar altimeters generally operate in three altitude regions, namely, low altitude (generally defined as from 0 to approximately 50 feet), medium altitude, and high altitude. During low altitude flight, an aircraft may be just above terrain, such as during landing, low altitude equipment drops, precision hovering, detection avoidance, and nap of the earth flying. Also, with unmanned vehicles, radar altimeter accuracy facilitates more accurate control of the flight path including during landings that are controlled remotely.

Operation in each altitude region involves complex processing and controls. Such complexity is evidenced by the number of processes performed by a radar altimeter. For example, there are multiple gating circuits, track and track/no track loops, gain control signals and loops (for example, Automatic Gain Control, Sensitivity Range Control, Noise Automatic Gain Control, and Power Management Control), signal integrators, and altitude signal generators and converters.

This complexity generally translates to increased material and labor costs for components, assembly, and testing. Also, with the various interactive loops and signal processing, error compensation typically is utilized to correct for offsets and other effects introduced by the various components and processes. In addition, altimeter resolution typically is dependent upon averaging schemes using low frequency reference clocks.

### BRIEF DESCRIPTION OF THE INVENTION

In one aspect, a method of radar altimeter operation, the altimeter including a high frequency counter coupled to a processor is provided. The method comprises providing a continuous wave to the high frequency counter upon receipt of a transmit pulse, counting the cycles of the continuous wave, discontinuing counting of the continuous wave cycles upon receipt of a return pulse, outputting a count from the high frequency counter to the processor, and operating the processor to convert the count to an altitude. Providing the continuous wave to the high frequency counter comprises periodically varying the frequency of the continuous wave to provide an agile frequency to the radar altimeter.

In another aspect, a radar altimeter is provided. The radar altimeter comprises a high frequency counter and a phase locked loop (PLL) circuit configured to provide a stable waveform to the high frequency counter. The radar altimeter also comprises a radio frequency (RF) switch configured to allow the stable waveform from the PLL circuit to enter the high frequency counter upon receipt of a transmit pulse, and the high frequency counter configured to count the pulses of the waveform, send a reset signal to the RF switch upon receipt of a return pulse, and output a count.

In another aspect, a method of track gate generation within a radar altimeter is provided. The method comprises providing a stable waveform and a first set number of cycles to a first high frequency counter, counting upon receipt of a start pulse to the first set number of cycles of the waveform and closing a track gate at that time, providing the stable waveform and a second set number of cycles to a second high frequency counter, and opening the track gate when the second set number of cycles is reached.

In still another aspect, a precision track gate generator is provided. The precision track gate generator comprises a phase locked loop (PLL) circuit configured to provide a stable waveform to a first and a second high frequency counter, a processor configured to provide a first set number of pulses to a first high frequency counter and a second set number of pulses to a second high frequency counter, the first high frequency counter configured to count pulses of the waveform and signal the start of a track gate pulse upon reaching the first set number of pulses, and the second high frequency counter configured to count pulses of the waveform and signal the end of the track gate pulse upon reaching a second set number of pulses.

### BRIEF DESCRIPTION OF THE DRAWINGS

FIG. 1 is a pulse diagram of a transmit pulse, a return pulse, an altitude pulse, and a timing signal.

FIG. 2 is a block diagram of a radar altimeter that includes a standard gate generator.

FIG. 3 is a detailed block diagram of a crystal oscillator, a phase locked loop (PLL) frequency synthesizer, and a voltage controlled oscillator 120.

FIG. 4 is a block diagram of a radar altimeter that includes a precision gate generator rather than a standard gate generator such as is shown in FIG. 3.

### DETAILED DESCRIPTION OF THE INVENTION

Methods and systems for radar altimeter signal processing are described herein. In one embodiment, a high frequency counter is utilized to control the timing of the radar altimeter. Such high frequency counter can be utilized, for example, to generate a tracking gate of the radar altimeter and to generate automatic gain control (AGC) pulse widths.

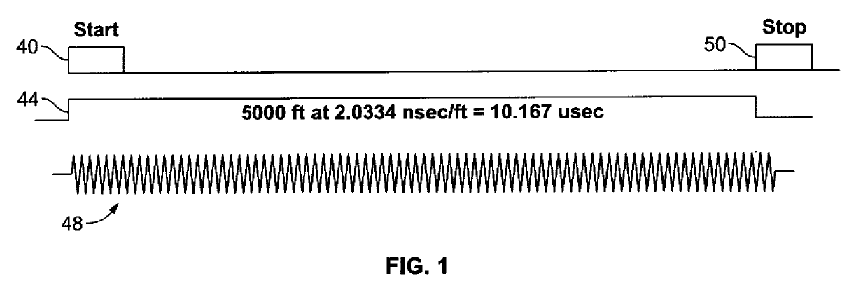

Referring now to the drawings, FIG. 1 is a pulse diagram illustrating a transmit pulse 40, a ground return pulse 50, an altitude pulse 44, and a high frequency timing signal 48. The leading edge of transmit pulse 40 triggers a switch to a high state forming the start of altitude pulse 44. The switch allows high frequency timing signal 48 to enter a counter and begin counting the pulses of an accurate high frequency timing signal 48. The leading edge of ground return pulse 50 resets the switch, which forms the trailing edge of altitude pulse 44, and stops high frequency timing signal 48 from entering the counter. Altitude pulse 44 has a pulse width that is proportional to the altitude. There is a two way path for transmit pulse 40 to travel. Transmit pulse 40 travels from a transmit antenna to a surface and back to a receive antenna. At the speed of light, the signal travels the two-way path at 2.0334 nsec/foot. At, for example, 5000 feet, altitude pulse width 44 would be 10.167 usec.

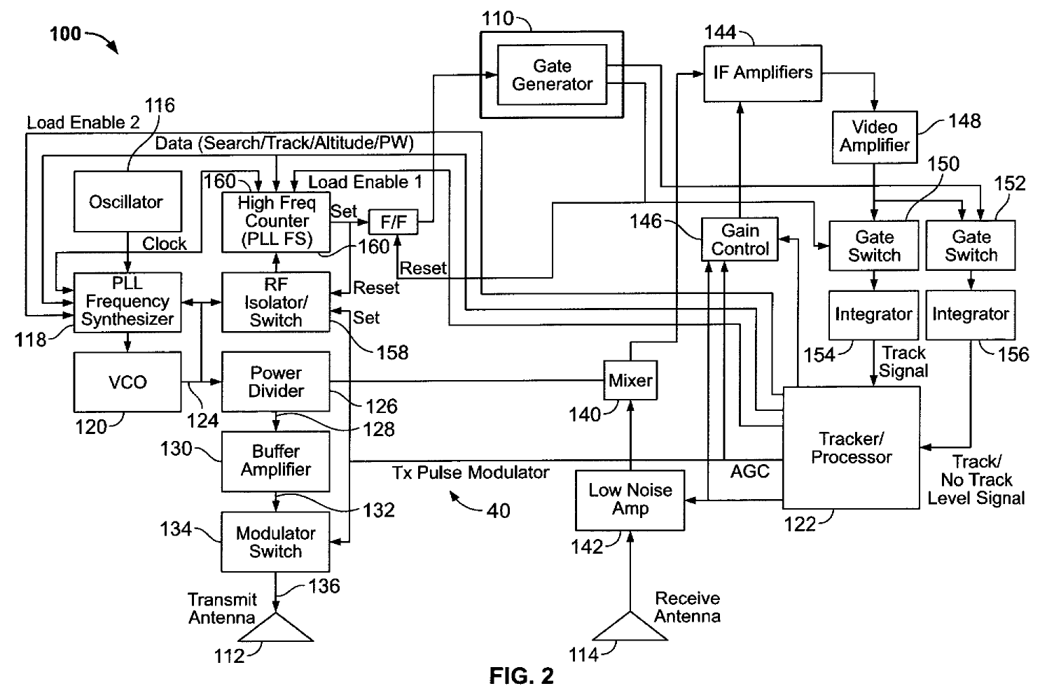

FIG. 2 is a block diagram of a radar altimeter 100 including a standard gate generator 110. Radar altimeter 100 includes a transmit antenna 112 and a receive antenna 114. Radar altimeter 100 also includes a crystal oscillator 116, for example, a temperature controlled crystal oscillator. Oscillator 116 provides an accurate reference frequency to a phase locked loop (PLL) frequency synthesizer 118. PLL synthesizer 118, in combination with a voltage controlled oscillator (VCO) 120, provides a stable frequency for radar altimeter 100. A tracker/processor 122 selects the frequency setting and supplies the setting to PLL synthesizer 118. Once the precise frequency is selected, PLL synthesizer 118, crystal reference oscillator 116, and VCO 120 maintain that frequency. The accuracy of the frequency produced by VCO 120 is a function of the accuracy of crystal reference oscillator 116 which, in one example, is temperature compensated and very stable. The accuracy of the frequency produced by VCO 120 is important because the accuracy of an altitude determined by radar altimeter 100 is a function of the accuracy of that frequency.

VCO 120 provides a frequency source for transmission and for down conversion of radar return pulses. More specifically, and with respect to transmission, VCO 120 provides a radio frequency (RF) signal 124 to a power divider 126. Power divider 126 outputs an RF signal 128 to buffer amplifier 130, which outputs an amplified RF signal 132 for transmission. The amplified RF signal 132 for transmission is provided to a modulator switch 134, which, depending on a state of modulator switch 134, modulates amplified RF signal 132 and routes the modulated output signal 136 to transmit antenna 112 for transmission as a radar signal towards the ground.

With respect to reception, VCO 120 provides an RF frequency signal to a mixer 140. Transmitted pulses are received at receive antenna 114 and amplified by a low noise amplifier 142. Mixer 140 demodulates the received signals with the frequency from VCO 120 after the received signals are amplified by low noise amplifier 142. The received signals are further amplified by an intermediate frequency (IF) amplifier 144. IF amplifier 144 is provided with a gain control signal from a gain control generator 146. Video amplifier 148 provides further amplification after the return signal is rectified. The signal is supplied to gate switches 150 and 152 and to integrators 154 and 156. Integrators 154 and 156 provide processor 122 with the timing for a tracking gate pulse as well as the track/no track gate pulse. The track gate pulse is utilized in the control loop to track the leading edge of the ground return signal. The track/no track gate pulse is utilized to sense the entire ground return signal to determine a track condition, transition the altimeter between modes, and measure the amplitude of the ground return signal. During the search mode, these gates are swept throughout the altitude range looking for the ground return signal. Once the track/no track gate pulse overlaps the ground return signal and there is sufficient signal strength, the search mode transitions into a track mode. In track mode, the track loops are controlled by the position of the ground return signal. In addition, the track/no track gate continues to overlap the ground return signal and measure the amplitude of the ground return signal. The track/no track gate generates an amplitude control signal in the gain control circuit 146, based on the measured amplitude, which maintains a constant ground return signal amplitude in the IF amplifiers 144.

Referring further to FIG. 2, VCO 120 is connected to an RF isolator/switch 158 which is connected to a high frequency counter 160. In one embodiment, a PLL frequency synthesizer contains high frequency counter 160. RF switch 158 closes upon receipt of transmit pulse 40. Closing RF switch 158 connects VCO 120 to high frequency counter 160. High frequency counter 160 counts the pulses from VCO 120. Processor 122 provides high frequency counter 160 with notice of receipt of ground return pulse 50. High frequency counter 160 then provides a pulse output to RF switch 158 that opens RF switch 158 and inhibits clocking of the pulses from VCO 120. The total number of pulses clocked is then converted to an altitude by processor 122.

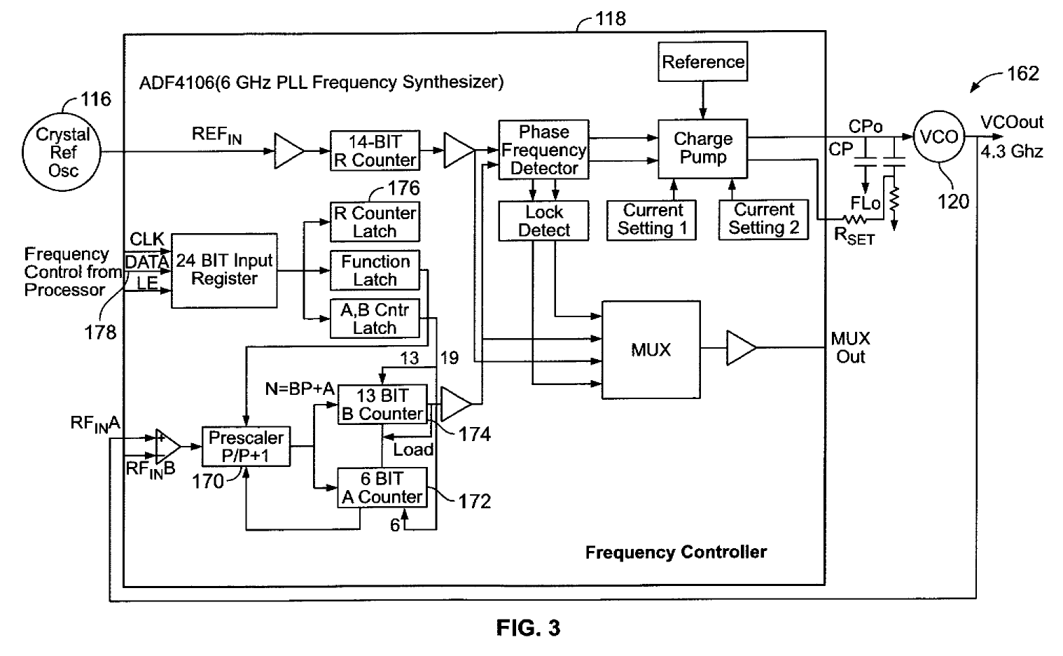

FIG. 3 is a detailed block diagram of crystal oscillator 116, PLL frequency synthesizer 118, and VCO 120. These components within radar altimeter 100 provide a stable frequency for radar altimeter 100. In one embodiment, PLL frequency synthesizer 118 is an ADF4106 6 GHz PLL Frequency Synthesizer, commercially available from Analog Devices, Inc. of Norwood, Mass. It is also possible to create a frequency synthesizer similar to PLL synthesizer 118 from discrete components. The combination of PLL synthesizer 118 and VCO 120 in a phase locked loop configuration, provides a stable frequency (VCO frequency) 162 for radar altimeter 100.

VCO 120 generates an output frequency shown as VCO frequency 162. In one embodiment, VCO frequency 162 is frequency hopped or changed to reduce the probability of intercept. However, the selected VCO frequency 162 is a known value (i.e., VCO frequency 162 is controlled to a specific frequency by processor 122) and stable once selected.

In one specific example, timing signal 48 (shown in FIG. 1) is pulse modulated by transmit pulse 40. VCO 120 is the source of the transmitter carrier frequency which is set at a specific frequency within the range 4.3±0.1 GHz, the allocated frequency band of the radar altimeter. VCO frequency 48 is stable and the precise frequency setting is known. Because of this stability, a very accurate altitude can be derived by modulating VCO frequency 48 and altitude pulse width 44. Modulating VCO frequency 48 with altitude pulse width 44 not only provides an accurate altitude determination, it also achieves a high resolution, in one numerical example, 0.11437 feet/pulse.

The following is one specific example of frequency control. More specifically, the following is one specific numerical example of the settings used to obtain control of VCO frequency 162 to 2 KHz. The frequency of crystal reference oscillator 116 is selected to be 20 MHz. A prescaler (P Counter) 170 is programmable and adjustable to divide by 8, 16, 32, or 64 (i.e., six bits). However, the maximum frequency for an A Counter 172 and a B Counter 174 is 325 MHz. Therefore, P Counter 170 must be set to divide by 16, 32, or 64.

A Counter 172 is a 6 bit counter and can be set to divide between 0 and 63. B Counter 174 is a 13 bit counter and can be set to divide between 3 and 8191. Therefore, the max count for P Counter 170 plus B Counter 174 plus A Counter 172 is 64 times 8191 times 63, which equals 33,026,112. An R counter 176 is 14 bits which can be set for divides up to 16,383.

To control to within a 2 KHz frequency, R counter 176 is set to a 10,000 divider (i.e., 20 MHz divided by 2 KHz). Counters P, A, and B are set to a 2,150,000 divider (i.e., 4,300 MHz divided by 2 KHz). These divider settings are set by processor 122 at a serial data port 178.

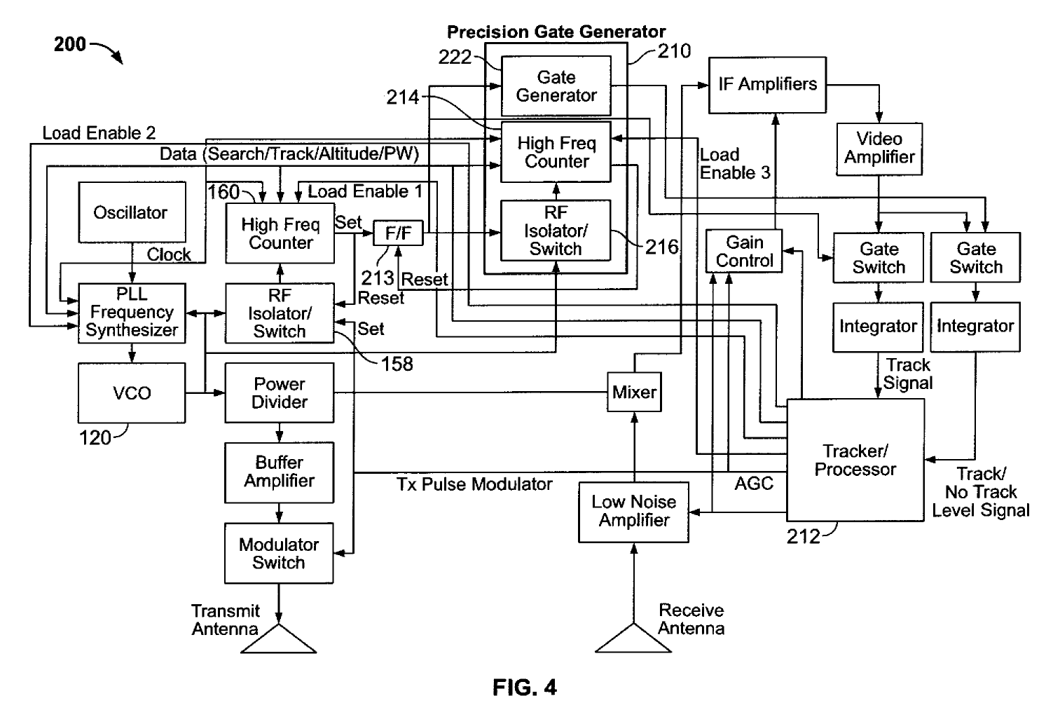

FIG. 4 is a block diagram of a radar altimeter 200 that includes a precision gate generator 210 rather than a standard gate generator such as standard gate generator 110 shown in FIG. 3. Precision gate generator 210 includes a high frequency counter 214 and an RF switch 216. In one embodiment, a PLL frequency synthesizer contains high frequency counter 214. Precision gate generator 210 is used to generate precision gate widths. Precision gate generator 210 uses essentially the same mechanization as described above in conjunction with high frequency counter 160 in combination with RF switch 158 and VCO 120 to set very accurate track gate widths.

Standard gate generator 110 and precision gate generator 210 are essentially switches that only allow selected samples of the radar return signal to be processed. The return signal can not get through the gate until the point in time at which the switch is closed. For example, if a radar gate is set to a range of 1000 feet, the gate will wait two microseconds (which is the amount of time corresponding to radar signals traveling about 2000 feet or a radar range of about 1000 feet) after transmission, and then close to allow the return signal to pass through. The time the switch is closed is referred to as the gate width. A processor 212 provides high frequency counter 160 with a count corresponding to a track gate interval. Processor 212 provides high frequency counter 214 with a count corresponding to a track gate width.

High frequency counter 160 counts the pulses from VCO 120 and upon reaching the track gate interval set by processor 212, provides a set pulse to a memory device 213. Memory device 213, for example a flip-flop, signals an RF switch 216 to trigger the track gate, and pulses from VCO 120 are provided to high frequency counter 214. High frequency counter 214 counts pulses from VCO 120 until reaching the number of pulses set by processor 212. High frequency counter 214 provides a reset pulse to memory device 213 upon reaching the set count, resulting in the proper track gate width, which is inputted to a gate switch.

The trailing edge of the track gate pulse overlaps the leading edge of the ground return signal and the track control loop maintains a fixed position. The accuracy of a radar altimeter is related to the accuracy of the track gate width. This is due to the track gate being positioned at its leading edge but tracking the return signal at its trailing edge. The accurate track gate width is also controlled. Processor 212 supplies a count to high frequency counter 214 corresponding to a track gate width. It is desirable to vary the track gate width as altitude changes. At low altitudes a narrow track gate width is desired so that the track gate is not interfered with by an antenna leakage signal. At higher altitudes, a wider track gate width is desired in order to receive more energy.

Memory device 213 also signals gate generator 222, which produces a track/no track gate pulse. This pulse is provided to the track/no track gate switch where it is utilized to measure amplitude of the ground return signal. The track/no track gate pulse overlaps the entire ground return signal (e.g., it is time co-incident with the track gate pulse but has a larger pulse width). The track/no track gate determines when to switch between search mode and track mode and also provides an automatic gain control (AGC). Memory device 213 is reset by high frequency counter 214 after a specified delay generates the desired pulse width of the track gate pulse. Since the track/no track pulse is wider than the track gate pulse, the track gate pulse triggers the gate generator 222 to obtain the wider pulse width.

The following is a numerical example of the accuracy of the altitude determinations made by radar altimeter 100. Altitude accuracy is a function of the stability of the reference oscillator. In one example, the oscillator is temperature compensated and provides very stable operation.

A quartz voltage control oscillator with temperature compensation, for example a T90 Series TCXO commercially available from Greenray Industries, Inc. of Mechanicsburg, Pa., has a frequency range of 10 MHz to 200 MHz, a temperature stability of 0.5 parts per million (ppM) from −20° C. to 70° C., less than 1 ppM/yr of affects from aging, and a frequency that is adjustable by 5 ppM.

At the above chosen 20 MHz reference oscillator frequency, the temperature stability equals (0.5×10⁻⁶) times (20×10⁶ Hz), which equals a variance of 10 Hz from −20° C. to 70° C.

The frequency synthesizer is set to 4,300 MHz. The stability of the frequency synthesizer is (4,300×10⁶)×(0.5×10⁻⁶), which equals a variance of 2,150 Hz from −20° C. to 70° C.

Converting the frequency stability to its effect on altitude shows that the error due to the change in frequency over a temperature range of −20° C. to 70° C. is negligible. The 4,300,000,000 Hz frequency has a pulse width of 0.23255814 nsec/pulse. Knowing that it takes a pulse 2.0334 nsec to travel one foot, 0.23255814 nsec/pulse can be converted to 0.114369106 ft/pulse. Performing the same analysis on a 4,300,002,150 Hz frequency yields a pulse width of 0.2325580233 nsec/pulse and a distance per pulse of 0.114369048 ft/pulse. This analysis determines the errors caused by VCO signal 162. This error does not include errors from the ground return signal shape or related processing signals.

A radar altimeter has two modes, search mode and track mode. In the search mode, the radar altimeter successively examines increments of range with each cycle of operation until the complete altitude range is searched for a ground return pulse. When the range is found, the radar altimeter switches to the track mode. In the track mode, the system locks onto and tracks the leading edges of the ground return pulses. It then sends continuous altitude information to the processor. The following are numerical examples of the accuracy of the described system in search mode and in track mode.

In search mode, a search rate of less than 0.25 seconds or 4 times every second is desired for the chosen application. The step resolution of the system with a 4.3 GHz carrier frequency equals the inverse of 4.3 GHz, which is 0.23256 nsec/pulse or 0.11437 feet/pulse. If an altitude range of 0 to 5,000 feet (i.e. 0 to 10,167 nsec) is desired to be searched, there would be a maximum of 43,717.76 pulses.

In search mode, the search is set in steps of 4×0.11437 ft which equals a resolution of 0.45748 feet/step or 0.93 nsec/step. Assuming a Pulse Repetition Frequency (PRF) of 100 KHz (i.e. 10 microseconds), the search time per cycle equals the 43,718 pulses divided by 4 pulses/step times 10 usec, which equals 0.1093 sec or 9.149 times/sec.

Therefore, there is sufficient resolution with 0.457 ft/step to search the altitude range in more than sufficient time (i.e., 9 times/sec compared to the desired at least 4 times/sec).

In track mode the step resolution is once again 0.23256 nsec/pulse because the carrier frequency is the same as in the above search mode example. This corresponds to 0.11437 ft/pulse. Therefore, the system can move the track gate at a rate of 0.11437 ft/10 usec, which is 0.09 msec/ft. This is more than sufficient time to track even a 4000 foot/sec altitude change.

The methods and apparatus described above provide a low cost, high resolution, and high accuracy radar altimeter. The methods and apparatus described above simplify the timing, gating, and AGC functions within a radar altimeter by utilizing radio frequency switches and high frequency counters, while also increasing the resolution and accuracy over known radar altimeters.

While the invention has been described in terms of various specific embodiments, those skilled in the art will recognize that the invention can be practiced with modification within the spirit and scope of the claims.

What is claimed is:

1. A method of track gate generation within a radar altimeter comprising:
providing a stable waveform and a first set number of cycles to a first high frequency counter;
counting upon receipt of a start pulse to the first set number of cycles of the waveform and closing a track gate at that time;
providing the stable waveform and a second set number of cycles to a second high frequency counter; and
opening the track gate when the second set number of cycles is reached.

2. A method of track gate generation according to claim 1 wherein providing a stable waveform and a first set number of cycles to a first high frequency counter comprises configuring a processor to provide the first set number of cycles to the first high frequency counter.

3. A method of track gate generation according to claim 1 wherein providing a stable waveform and a second set number of cycles to a second high frequency counter comprises configuring a processor to provide the second set number of cycles to the second high frequency counter.

4. A method of track gate generation according to claim 1 wherein providing a stable waveform to a first high frequency counter comprises configuring a phase locked loop circuit to provide the stable waveform to the first high frequency counter for counting.

5. A method of track gate generation according to claim 1 wherein providing a stable waveform to a second high frequency counter comprises configuring a phase locked loop circuit to provide the stable waveform to the second high frequency counter for counting.

6. A method of track gate generation according to claim 1 wherein providing a stable waveform to a second high frequency counter comprises configuring the first high frequency counter, upon reaching the first set number of cycles, to provide a set pulse to a memory device, and configuring the memory device to output a start pulse to an RF switch configured to pass the stable waveform to the second high frequency counter for counting.

7. A method of track gate generation according to claim 1 wherein counting upon receipt of a start pulse to the first set number of cycles of the waveform and closing a track gate at that time comprises configuring the first high frequency counter, upon reaching the first set number of cycles, to provide a set pulse to a memory device, and configuring the memory device to output a start pulse to a gate generator and a gate switch, signaling the gate generator and the gate switch to close a track/no track gate and a track gate.

8. A method of track gate generation according to claim 1 wherein opening the track gate when the second set number of cycles is reached comprises configuring the second high frequency counter to provide a reset pulse to the memory device upon reaching the second set number of cycles and configuring the memory device to signal a gate switch to open a track gate.

9. A precision track gate generator comprising;
a phase locked loop (PLL) circuit configured to provide a stable waveform to a first and a second high frequency counter;
a processor configured to provide a first set number of pulses to said first high frequency counter and a second set number of pulses to said second high frequency counter;
said first high frequency counter configured to count pulses of the waveform and signal the start of a track gate pulse upon reaching the first set number of pulses; and
said second high frequency counter configured to count pulses of the waveform and signal the end of the track gate pulse upon reaching a second set number of pulses.

10. A precision track gate generator according to claim 9 wherein said first high frequency counter is configured to provide a set pulse to a memory device upon reaching the first set number of pulses.

11. A precision track gate generator according to claim 10 wherein said memory device is configured to provide a start pulse to a radio frequency (RF) switch, said RF switch is configured to pass the stable waveform to said second high frequency counter upon receipt of the start pulse.

12. A precision track gate generator according to claim 10 wherein said memory device is configured to signal a gate switch to close a track gate.

13. A precision track gate generator according to claim 10 wherein said memory device is configured to signal a gate generator to close a track/no track gate.

14. A precision track gate generator according to claim 9 wherein said second high frequency counter is configured to provide said memory device with a reset pulse upon reaching a second set number of pulses.

15. A precision track gate generator according to claim 14 wherein said memory device is further configured to signal the gate switch to open the track gate upon receipt of the reset pulse.
